(19) United States
(12) Patent Application Publication
(10) Pub. No.: US 2006/0290596 A1
(43) Pub. Date: Dec. 28, 2006

(54) Plasma display device

(76) Inventors: Tae-Joung Kweon, Suwon-si (KR); Kyoung-Doo Kang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/449,081

(22) Filed: Jun. 8, 2006

(30) Foreign Application Priority Data
Jun. 8, 2005 (KR) 10-2005-0048783

(51) Int. Cl. G09G 3/28

(52) U.S. Cl. 345/60

(57) ABSTRACT

Disclosed is a plasma display device. The plasma display device including a plurality of display segments is disclosed. The edges of the display segments face each other and form a larger display device. The display segment includes first and second electrodes crossing each other where the discharge cell is located. The discharge cell is discharged with only the first and second electrodes.

### CROSS-REFERENCE TO RELATED APPLICATION

The application claims priority to and the benefit of Korean Patent Application No. 10-2005-0048783 filed in the Korean Intellectual Property Office on Jun. 8, 2005 of the earlier filing date, the contents of which are herein incorporated by reference in their entirety.

### BACKGROUND

1. Field

The present invention relates to a display device, more particularly a plasma display panel (PDP)including a plurality of segments arranged to form a single display surface.

2. Description of the Related Technology

Recently, the size of display devices tends to be significantly increasing. The PDP devices are not an exception. However, there are a number of limitations to produce PDP devices, particularly fabricating the device on a single glass plate.

### SUMMARY OF CERTAIN INVENTIVE ASPECTS

One aspect of the invention provides a plasma display device comprising a plurality of display segments, which comprises a first display segment and a second display segment. The first display segment comprises a first display surface, a first edge of the first display surface, a discharge cell, a first electrode extending in a first direction and passing by the discharge cell, and a second electrode extending in a second direction other than the first direction and passing by the discharge cell. The first display segment is configured to create an address-discharge within the discharge cell by applying an address voltage between the first and second electrodes. The first display segment is further configured to create a sustain-discharge within the discharge cell by applying a sustain voltage between the first and second electrodes. The second display segment comprises a second display surface and a second edge of the second display surface. The first and second display segments are arranged such that the first and second edges face each other and extend substantially in parallel and that the first and second display surfaces in combination form a substantially planar display surface. Neither of the first and second electrodes extends into the second display segment.

In the above-described plasma display device, the first and second directions cross at the discharge cell. The first direction may be substantially parallel to the first edge, wherein the second direction may be substantially perpendicular to the first edge, and wherein the second electrode does not cross the first edge. The first display surface may further comprise an opposing edge opposing the first edge, and wherein the second electrode may comprise a first terminal in the vicinity of the first edge and a second terminal in the vicinity of the opposing edge, and wherein the second electrode generally extends between the first and second terminals. The device may further comprise a driving circuit configured to drive the first display segment outside the first display segment. The device may further comprise an electrical connection between the driving circuit and the second electrode, and wherein the electrical connection contacts the second terminal. The electrical connection does not directly contact the first terminal.

Still in the above-described plasma display device, the first display segment may further comprise a plurality of electrodes extending in either of the first and second directions. None of the plurality of electrodes extends into the second display segment. The first display segment does not comprise an electrode configured to participate in creating a discharge within the discharge cell. The second display segment may further comprise a discharge cell, a first electrode, and a second electrode, the first electrode extending in a first direction and passing by the discharge cell, the second electrode extending in a second direction other than the first direction and passing by the discharge cell. The second display segment may be configured to create an address-discharge within the discharge cell by applying an address voltage between the first and second electrodes of the second display segment. The second display segment may be further configured to create a sustain-discharge within the discharge cell by applying a sustain voltage between the first and second electrodes of the second display segment. Neither of the first and second electrodes of the second display segment extends into the first display segment.

Still in the above-described plasma display device, the first display segment may further comprise a plurality of barrier ribs. The first and second electrodes may be buried in the plurality of barrier ribs. The first and second edges may contact each other. The first display segment may comprise a first glass panel comprising the first display surface, wherein the second display segment may comprise a second glass panel comprising the second display surface, and wherein the first and second glass panels may be bonded together. The device may further comprise a strip between the first and second edges. The first and second display segments as a whole may comprise a single glass panel comprising a surface; at least part of the surface of the single glass panel may comprise the first and second display surfaces; and there may be no physical boundary between the first and second display surfaces. The single glass panel does not comprise a trace of bonding along either or both of the first and second edges. Each of the first and second display surfaces has a shape selected from the group consisting of a square, a rectangle, a triangle and a polygon. The first and second display surfaces may be substantially rectangular and of the same size. The device may further comprise a plurality of display segments, each of which comprises a display surface and an edge; the plurality of display segments are arranged such that the display surfaces of the plurality of display segments in combination with the first and second display surfaces form a single display surface, which is substantially planar.

Another aspect of the invention provides methods of displaying an image. One method comprises providing the above-described device and stimulating the device so as to simultaneously display a first image on the first display surface and a second image on the second display surface. Another method comprises providing the device and stimulating the device so as to display a single image on the substantially planar display surface.

Another aspect of the present invention is a plasma display device including a front substrate, a rear substrate being spaced apart from the front substrate, a discharge cell formed between the front and rear substrate and groups of electrodes formed between the front and rear substrates and spaced apart from each other. At least one group of electrodes includes a first and a second electrodes passing by the discharge cell and crossing each other where the discharge cell is located such that the discharge cell is addressed and discharged with only the first and second electrodes. The groups of electrodes may do not interact with each other. At least two electrodes of the group of the electrodes, which are extended in a direction to cross a space between the groups of electrodes, may be still parallel to each other near the space between the groups of electrodes. The first electrode may be extended to three-dimensionally cross the second electrode. An address pulse may be applied to the first electrode while a scan pulse may be applied to the second electrode during address discharge. A sustain pulse may be applied to the first electrode and the second electrode during sustain discharge.

Another aspect of the present invention provides a method for manufacturing the plasma display device including providing the plurality of display segments, abutting edges of the plurality of display segments together, and welding the abutted edges of the plurality of display segments. The providing the plurality of display segments may include forming electrodes to be parallel to each other near a borderline formed between the neighboring display segments. The electrodes may include first and second electrodes and the first electrode three-dimensionally cross the second electrode. At least one of the electrodes may be drawn out from edges of the display segments to be away from the borderline.

Another aspect of the present invention provides a method for manufacturing the plasma display device including providing an intermediate product for forming the groups of electrodes thereon and forming the groups of electrodes on the intermediate product. The forming of the groups of electrodes on the intermediate product includes forming first group of the electrodes, and forming second group of the electrodes to be spaced apart from the first group of the electrodes. The forming the groups of electrodes may include forming the first electrodes of the first group of the electrodes to be parallel to each other near a space between the first and second groups of electrodes. The forming the groups of electrodes may include three-dimensionally crossing the first electrode with the second electrode.

Another aspect of the present invention provides a method for displaying an image including providing the plasma display device, stimulating the device to create a plasma discharge. The plasma discharge activates phosphors formed in the discharge cell to emit light from the display surface and the emitted light contributes to display of an image on the display surface. The electrodes in each of the neighboring display segments may do not interact with each other such that an image is not displayed near where the first and second edges face each other when the device is stimulated to create a plasma discharge. The method of for displaying an image further includes synchronizing images displayed on each of the display segments.

### BRIEF DESCRIPTION OF THE DRAWINGS

The above and other features and aspects of the present invention will become more apparent by describing certain embodiments of the invention with reference to the attached drawings.

FIG. 1 is a perspective view of a PDP in accordance with an embodiment;

FIG. 2 is a plan view of assembling the PDP of FIG. 1.

FIG. 3 illustrates configuration and arrangement of two electrodes in accordance with an embodiment.

FIG. 4 is a partial cross-sectional view of a plane taken along the line IV-IV of FIG. 2.

FIG. 5 is a partial cross-sectional view of a plane taken along the line V-V of FIG. 4.

FIG. 6 is a partial cross-sectional view of a plane taken along the line VI-VI of FIG. 4.

FIG. 7 is a perspective view of a PDP in accordance with an embodiment.

### DETAILED DESCRIPTION OF EMBODIMENTS

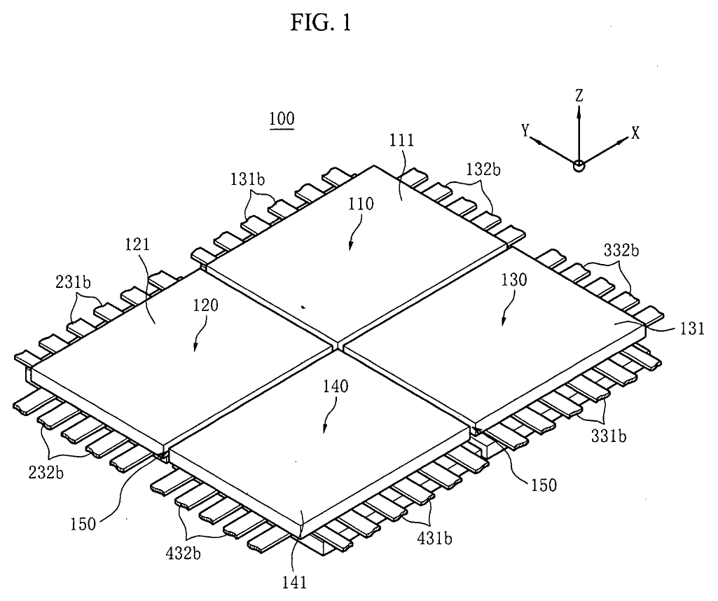

Hereinafter, embodiments of the present invention will be described with reference to FIGS. 1 to 7. These embodiments are merely to illustrate various features and aspects of the present invention, and the present invention is not limited to the illustrated embodiments. In embodiments, like elements are referred to with like reference numbers.

Referring to FIG. 1, the PDP device 100 according to an embodiment includes four display segments 110, 120, 130 and 140. Each of the four display segments 110, 120, 130 and 140 is a PDP device having a display surface 111, 121, 131, 141. The four display segments 110, 120, 130 and 140 are arranged such that the display surfaces 111, 121, 131 and 141 of the display segments 110, 120, 130 and 140 form a single and generally planar display surface, which is referred to as an aggregate display surface. In the illustrated embodiment, there is a gap 150 along the boundaries between two neighboring display segments. The size of the gap 150 may vary among embodiments. The gap may be filled with bonding materials to combine neighboring display segments together. In some embodiments, display segments are arranged such that substantially no gap may be formed between two neighboring segments.

In embodiments, each display segment 110, 120, 130 and 140 can display an image on its own display surface independent of the other display segments. Also, the display segments 110, 120, 130 and 140 can display an image on the aggregate display surface. The display segments 110, 120, 130 and 140 can also display an image on a part of the aggregate display surface rather than the whole aggregate display surface, and the remaining of the aggregate display surface may display another image independent of the other part. In embodiments, the PDP device 100 includes one or more circuits or processors configured to display various images on each segment PDP or on the aggregate display surface. In some embodiments, each segment PDP includes a display control circuit or processor (not shown) to display an image in its own display surface. In some embodiments, a central control circuit or processor (not shown) coordinates and synchronizes processing of each of the display control circuit or processor for each display segment.

Although the foregoing embodiments are discussed in terms of a PDP device having four display segments, the number of display segments may vary in other embodiments. In some embodiments, PDP devices may includes 1, 2, 3, 4, 5, 6, 7, 8, 9, 10, 11, 12, 13, 14, 15, 16, 17, 18, 19, 20, 21, 22, 23, 24, 25, etc. of display segments. More generally, the PDP devices of embodiments may be formed of at least two display segments. Although the foregoing discussion and embodiments involve only PDP devices, the features and aspects of the invention can also be used in other display devices including organic light emitting display (OLED) devices with or without certain modifications in their configurations.

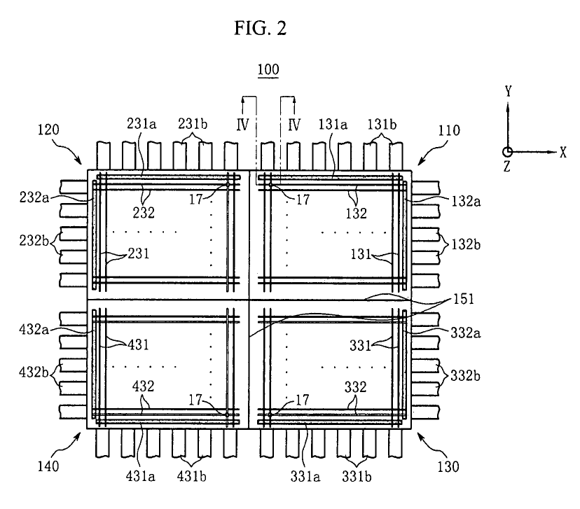

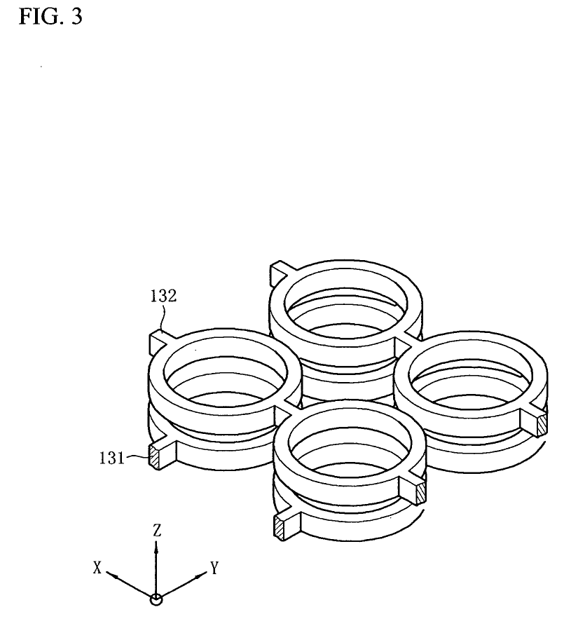

The PDP device 100 of FIG. 1 includes a number of flexible circuit films 131b, 132b, 231b, 232b, 331b, 332b, 431b and 432b which will be further discussed with reference to FIG. 2. Now referring to FIG. 2, the electrodes 131, 231, 331 and 431 are sustain/address electrodes of the display segments 110, 120, 130 and 140, respectively. The electrodes 132, 232, 332 and 432 are sustain/scanning electrodes of the segment PDPs 110, 120, 130 and 140, respectively. Discharge cells (not shown) are formed in areas where sustain/addresses 131, 231, 331 and 431 intersect with sustain/scanning electrodes 132, 232, 332 and 432b. In one embodiment, a discharge cell is selected to turn on when two electrodes intersecting at the discharge cell are stimulated. The configuration and activation of discharge cells will be further discussed later with reference to FIGS. 3, 5 and 6.

As illustrated in FIG. 2, the sustain/address electrodes 131, 231, 331, and 431 are formed to extend in a direction to be parallel to the short edges of the first to fourth display segments 110, 120, 130, and 140, and are arranged along a longitudinal direction (X-axis direction). First electrode terminals 131a, 231a, 331a, and 431a, each of which is a bundles of a plurality of sustain/address electrodes 131, 231, 331, and 431, respectively, are drawn out to long edge of the first to fourth display segments 110, 120, 130 and 140. The first electrode terminals 131a, 231a, 331a, and 431a are connected to each of their circuit board assemblies (not shown) through flexible circuit films 131b, 231b, 331b, and 431b, respectively. The first electrode terminals 131a, 231a, 331a, and 431a are drawn as lines in FIG. 2 for the sake of convenience. In fact, they can be more concentrated as they go to the edges of the display segments 110, 120, 130, and 140 and then can be seen as lines as illustrated in FIG. 2.

Second electrode terminals 132a, 232a, 332a, and 432a, which are connected to the address/scanning electrodes 132, 232, 332, and 432, are drawn out to edges of the display segments 110, 120, 130 and 140. The drawing directions of the second electrode terminals 132a, 232a, 332a, and 432a make a right angle with those of the first electrode terminals 131a, 231a, 331a, and 431a. The second electrode terminals 132a, 232a, 332a, and 432a are connected to each of their circuit board assemblies (not shown) through the flexible circuit film 132b, 232b, 332b, and 432b, respectively. The second electrode terminals 132a, 232a, 332a, and 432a 2222 are drawn as lines in FIG. 2 for the sake of simplicity and convenience. In fact, they can be more concentrated as they go to the edges of the display segments 110, 120, 130, and 140 and then can be seen as lines as illustrated in FIG. 2.

The drawing directions of the electrodes will be explained in detail below with reference to FIG. 2. The first electrode terminals 131a are drawn out along a plus Y-axis, and the second electrode terminals 132a are drawn out along a plus X-axis in the first display segment 110. The first electrode terminals 231a are drawn out along a plus Y-axis and the second electrode terminals 232a are drawn out along a minus X-axis in the second display segment 120. The first electrode terminals 331a are drawn out along a minus Y-axis and the second electrode terminals 332a are drawn out along a plus X-axis in the third display segment 130. The first electrode terminals 431a are drawn out along a minus Y-axis and the second electrode terminals 432a are drawn out along a minus X-axis in the fourth display segment 410.

The borderlines 151 are away from the edges from which the first electrode terminals 131a, 231a, 331a, and 431a and second electrode terminals 132a, 232a, 332a, and 432a are drawn out. The borderlines are 151 abutted together and then the first to fourth display segments 110, 120, 130, and 140 are combined together. The first electrode terminals 131a, 231a, 331a, and 431a and the second electrode terminals 132a, 232a, 332a, and 432a are drawn out from all four edges of the PDP.

At least one electrode is extended in a direction to cross the borderlines 151 without crossing them. Furthermore, it may not be extended to borderlines 151 of the display segments 110, 120, 130 and 140. Therefore, electrodes of the neighboring display segments are not electrically connected to each other at the borderlines 151. Accordingly, it is possible to simply combine display segments 110, 120, 130 and 140 and then make the PDP device 100 with a larger display surface.

As illustrated in FIG. 2, the electrodes are not bundled or concentrated near the borderlines 151, so blocking lines do not appear. That is, the electrodes, which are extended in a direction to cross the borderline, are still parallel to each other near the borderline 151 and are not concentrated together. Therefore, a clearly connected large image along borderlines is displayed on the large PDP. Meanwhile, electrodes are bundled or concentrated near the edges that are away from the borderlines 151 in order to be connected to an external circuit.

Electrode terminals of the small PDPs may be overlapped when the small PDPs are combined together so to make a large display surface. As a result, it is difficult to suitably arrange wires of the terminals thereof. Furthermore, a plurality of electrodes is concentrated together near the borderlines of the neighboring PDPs. Therefore, long black lines due to the concentration of the electrodes are formed near borderlines of the PDPs. As a result, the display quality of the PDP may be deteriorated. On the contrary, the electrodes are not concentrated and are not overlapped with each other in borderlines 151 of the first to fourth display segments 110, 120, 130, and 140 in embodiments. Therefore, clear image can be displayed.

An internal structure of each display segment included in the PDP device will be explained in detail with reference to FIG. 3 to FIG. 6 below. The internal structures of the first to fourth display segments 110, 210, 310, and 410 are almost identical except drawing directions of the electrode terminals. Therefore, the internal structure of the display segment will be explained below based on the first display segment 110, and the first display segment 110 is referred to as display segment hereinafter for convenience.

FIG. 3 shows an example of a specific configuration of the electrodes that can be applied to the display segment of FIG. 2. The configuration of the electrodes shown in FIG. 3 is merely to illustrate an embodiment and the present invention is not limited to the embodiment. Therefore, a configuration of the electrodes can be modified in other forms. For example, three or more electrodes can be applied to the display segment. In addition, the electrodes can be shaped as a rectangle.

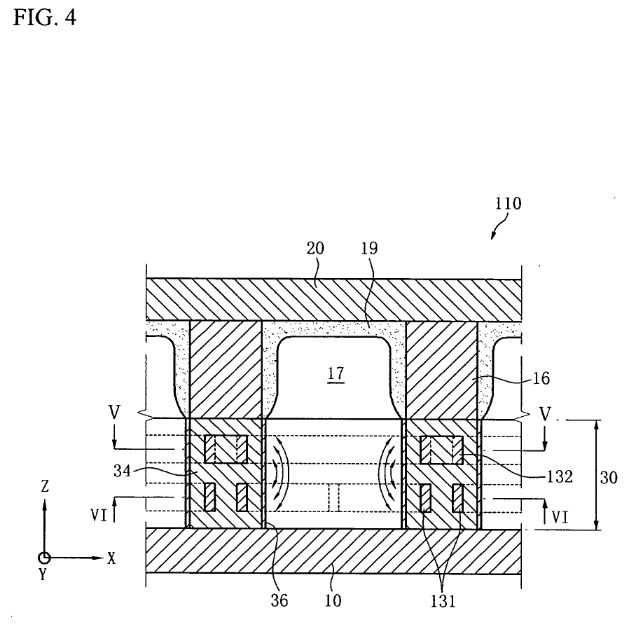

As illustrated in FIG. 3, a plurality of sustain/address electrodes 131 are extended in a Y-axis. Each of the sustain/address electrode corresponds to discharge cells (shown in FIG. 4) that are adjacent to each other in the Y-axis. In addition, a plurality of sustain/address electrodes 131 are arranged side by side with a predetermined interval in an X-axis. Meanwhile, a plurality of sustain/scanning electrodes 132 extend in X-axis. Each of the sustain/scanning electrodes corresponds to discharge cells (shown in FIG. 4) that are adjacent to each other in the X-axis. In addition, a plurality of sustain/scanning electrodes 132 are arranged side by side with a predetermined interval in -axis.

The sustain/address electrodes 131 are continuously formed to three-dimensionally cross the sustain/scanning electrodes 132 in order to address one discharge cell by address pulses applied to the sustain/address electrodes 131 while scan pulses are applied to the sustain/scanning electrodes 132. The sustain/scanning electrodes 132 generate a sustain discharge by sustain pulses that are alternately applied to the sustain/address electrode 131 in the discharge cell which is selected by the address discharge, and thereby an image is displayed.

Meanwhile, the sustain/address electrodes 131 and the sustain/scanning electrodes 132 can play different roles by signal voltages applied thereto. Therefore, a relationship between the electrodes and the signal voltages is not limited to the aforementioned state in which the signal voltages are applied to the electrodes.

The internal structure of the display segment 10 illustrated in FIG. 4 can be applied to the plane that is cut along a line IV-IV of FIG. 2. The electrodes illustrated in FIG. 3 can be also conformed to the display segment 110 illustrated in FIG. 4. The internal structure of the display segment 110 illustrated in FIG. 4 is merely to illustrate an embodiment, and the present invention is not limited to the embodiment.

Referring to FIG. 4, the display segment 110 includes a first substrate 10 (hereinafter referred to as a “rear substrate”), a second substrate 20 (hereinafter referred to as a “front substrate”), and barrier ribs 16. The rear substrate 10 and the front substrate 20 are spaced from each other with a predetermined interval and the barrier ribs 16 are provided therebetween.

The barrier ribs 16 partition a plurality of discharge cells 17 between the rear substrate 10 and the front substrate 20. Although the barrier ribs 16 are illustrated to be formed near the front substrate 20, this is merely to illustrate the present invention and the present invention is not limited thereto. Therefore, the barrier ribs 16 can also be formed near the rear substrate 10. Furthermore, the barrier ribs 16 can be separately formed on the substrates or be integrally formed on the substrates.

In addition, the discharge cell 17 can be formed to be provided with the barrier ribs 16, and can be formed by etching the front substrate 20 or the rear substrate 10. In FIG. 4, the discharge cell 17 is exemplified to be formed to be provided with the barrier rib 16 on the front substrate 20.

The barrier ribs 16 allow the discharge cell 17 to have various shapes such as a rectangle, a hexagon, and so on. In embodiments, the discharge cell 17 is exemplified to be shaped as a ring. A distance from an inner surface of the ring-shaped discharge cell 17 to a center thereof is uniform.

The discharge cells 17 are provided with phosphors 19 which absorb vacuum ultraviolet rays and emit visible rays. In addition, the discharge cells 17 are filled with a discharge gas in order to generate vacuum ultraviolet rays by plasma discharge. For example, the discharge gas can be a mixed gas including Ne, Xe, and so on.

The phosphors 19 are formed to cover the barrier ribs 16 and the front substrate 20. The phosphors 19 are formed to be transmissible in order to absorb vacuum ultraviolet rays in the discharge cell 17 and transmit visible rays through the front substrate 20.

The phosphors 10 can also be formed on the rear substrate 10 or can be formed on both of the substrates 10 and 20. It is preferable that the phosphors(not shown), which are formed on the rear substrate 10, are formed to be reflective in order to absorb vacuum ultraviolet rays inside and reflect visible rays to the front substrate 20.

In order to display an image by generating vacuum ultraviolet rays which are to collide with the phosphors 19, the sustain/address electrode 131 and the sustain/scanning electrode 132, which correspond to each of the discharge cells 17, are provided between the rear substrate 10 and the front substrate 20.

The sustain/address electrode 131 and the sustain/scanning electrode 132 are provided between both of the substrates 10 and 20 to form a separated electrode layer 30. The electrode layer 30 is provided on the rear substrate 10 while the barrier ribs 16 are provided on the front substrate 20. The sustain/address electrode 131 can surround the discharge cell 17 in a side of the rear substrate 10, while the sustain/scanning electrode 132 can surround the discharge cell 17 in a side of the front substrate 20. The sustain/address electrode 131 and the sustain/scanning electrode 132 are also spaced apart from each other in the electrode layer 30 along Z-axis.

Since the sustain/address electrode 131 and the sustain/scanning electrode 132 are disposed not on the discharge cell 17 but on sides of the discharge cell 17, they do not block the visible rays. Therefore, they can be made of metals with good conductivity which are not transparent. The sustain/address electrode 131 and the sustain/scanning electrode 132 are buried in the dielectric layer 34 and then electrically insulated from each other.

The electrode layer 30 includes the dielectric layer 34, the sustain/address electrode 131 and the sustain/scanning electrode 132. The dielectric layer 34 usually accumulates wall charges during discharge. They also allow each of the electrodes to be insulated. It is preferable that the dielectric layer be shaped as a ring corresponding to the structure of the barrier ribs 16.

The dielectric layer 34 forms a discharge cell 17 with the barrier ribs 16, and thereby the dielectric layer 34 is preferably covered with a protective layer 36 toward an inner side of the discharge cell 17. In particular, the protective layer 36 can be formed on portions which are exposed to a plasma discharge generated in the discharge cell 17.

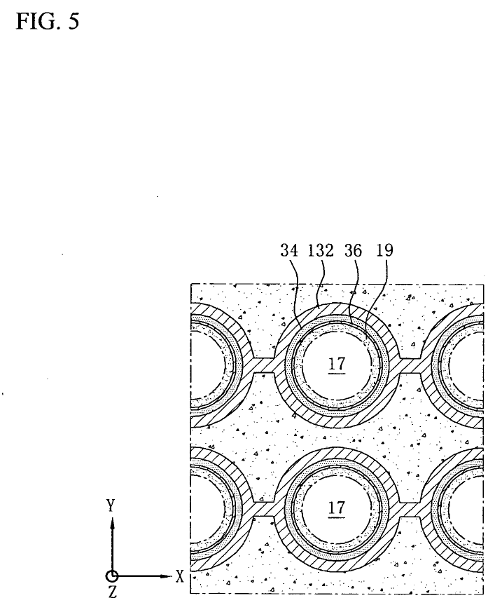

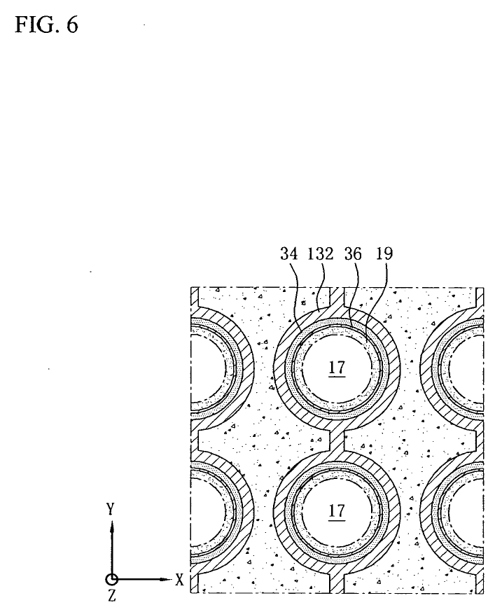

The detailed structure of the discharge cell 17 will be explained with reference to plan views thereof which are shown in FIGS. 5 and 6. FIGS. 5 and 6 show a sectional view along a line V-V and a line VI-VI of FIG. 4, respectively. As shown in FIG. 5, the sustain/scanning electrodes 132 are extended in X-axis while surrounding the discharge cells 17. In addition, as shown in FIG. 6, the sustain/address electrode 131 are extended in Y-axis while surround the discharge cells 17.

The protective layers 36 are required to protect the dielectric layer 34 and have a high secondary electron emission coefficient. However, they do not have to have a property to transmit visible rays since they are disposed to surround boundary of the discharge cells and then do not block visible rays. Therefore, the protective layer 36 may be made of materials that do not transmit visible rays. For example, opaque MgO can be used as a material of the protective layer 36. A high secondary electron emission coefficient of opaque MgO is higher than that of transparent MgO, and thereby a value of initiating discharge voltage can be further lowered.

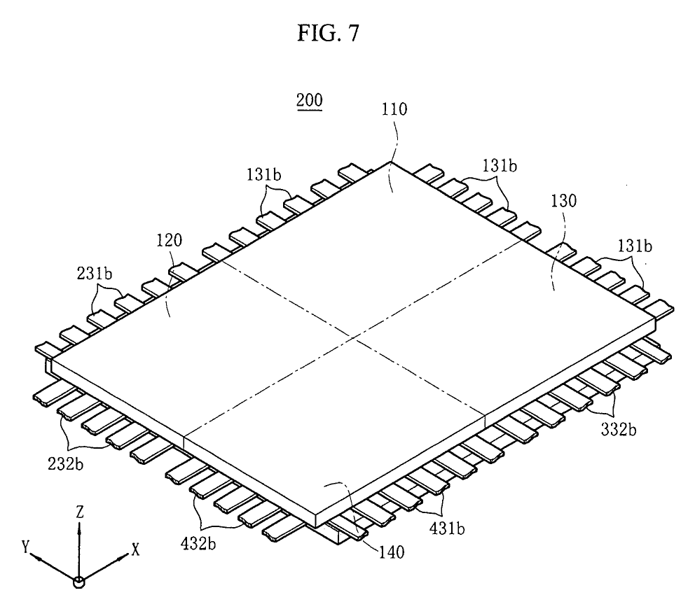

Another embodiment will be explained in detail with reference to FIG. 7 below. The embodiment is merely to illustrate the present invention and the present invention is not limited the embodiment. In embodiments, like elements are referred to with like reference numbers. FIG. 7 illustrates another PDP device 200. A front substrate is manufactured by using one glass plate. The PDP device 200 can be manufactured by processes of attaching a pre-manufactured group of electrodes to the rear substrate and then attaching the front substrate to the pre-manufactured group of electrodes. Since the PDP device 200 can be manufactured at one time by using such processes, manufacturing processes are simple.

The rear substrate can be made of one glass plate in the segregate PDP device 200, and both of the substrates can be made of one glass plate. In this case, the first to fourth display segments 110, 120, 130, and 140 can independently operate or operate together. The images displayed thereon can be synchronized.

In this case, each group of the electrodes disposed in each of the display segments 110, 120, 130 and 140 is spaced apart from and do not interact with each other. Therefore, an image is not displayed between neighboring groups of electrodes. Namely, images are not displayed near areas indicated by single-dotted lines in FIG. 7. However, the size of the PDP device 200 is so large that the non-display areas are not distinguishable if it is seen from a distance.

As described above, in embodiments, the segregate PDP device includes a plurality of display segments. More specifically, each of the display segments includes a plurality of discharge cells capable of being discharged with only first and second electrodes. The plurality of display segments are assembled together by attaching the sides thereof from which electrode terminals are not drawn out. As a result, the electrode terminals are not distinguished from a display surface when image is displayed on the display surface.

Although the invention has been described in terms of embodiments, those skilled in the art will appreciate that the embodiments may be modified in various forms without departing from the spirit and scope of the appended claims.

What is claimed is:

1. A plasma display device comprising a plurality of display segments, which comprises a first display segment and a second display segment;
wherein the first display segment comprises:
a first display surface,
a first edge of the first display surface,
a discharge cell,
a first electrode extending in a first direction and passing by the discharge cell, and
a second electrode extending in a second direction other than the first direction and passing by the discharge cell;
wherein the first display segment is configured to create an address-discharge within the discharge cell by applying an address voltage between the first and second electrodes;
wherein the first display segment is further configured to create a sustain-discharge within the discharge cell by applying a sustain voltage between the first and second electrodes;
wherein the second display segment comprises a second display surface and a second edge of the second display surface;
wherein the first and second display segments are arranged such that the first and second edges face each other and extend substantially in parallel and that the first and second display surfaces in combination form a substantially planar display surface; and
wherein neither of the first and second electrodes extends into the second display segment.

2. The device of claim 1, wherein the first and second directions cross at the discharge cell.

3. The device of claim 1, wherein the first direction is substantially parallel to the first edge, wherein the second direction is substantially perpendicular to the first edge, and wherein the second electrode does not cross the first edge.

4. The device of claim 3, wherein the first display surface further comprises an opposing edge opposing the first edge, and wherein the second electrode comprises a first terminal in the vicinity of the first edge and a second terminal in the vicinity of the opposing edge, and wherein the second electrode generally extends between the first and second terminals.

5. The device of claim 4, further comprising a driving circuit configured to drive the first display segment outside the first display segment, the device further comprising an electrical connection between the driving circuit and the second electrode, and wherein the electrical connection contacts the second terminal.

6. The device of claim 5, wherein the electrical connection does not directly contact the first terminal.

7. The device of claim 1, wherein the first display segment further comprises a plurality of electrodes extending in either of the first and second directions, and wherein none of the plurality of electrodes extends into the second display segment.

8. The device of claim 1, wherein the first display segment does not comprise an electrode configured to participate in creating a discharge within the discharge cell.

9. The device of claim 1, wherein the second display segment further comprises a discharge cell, a first electrode, and a second electrode, the first electrode extending in a first direction and passing by the discharge cell, the second electrode extending in a second direction other than the first direction and passing by the discharge cell, and wherein the second display segment is configured to create an address-discharge within the discharge cell by applying an address voltage between the first and second electrodes of the second display segment, wherein the second display segment is further configured to create a sustain-discharge within the discharge cell by applying a sustain voltage between the first and second electrodes of the second display segment, and wherein neither of the first and second electrodes of the second display segment extends into the first display segment.

10. The device of claim 1, wherein the first display segment further comprises a plurality of barrier ribs, and wherein the first and second electrodes are buried in the plurality of barrier ribs.

11. The device of claim 1, wherein the first and second edges contact each other.

12. The device of claim 1, wherein the first display segment comprises a first glass panel comprising the first display surface, wherein the second display segment comprises a second glass panel comprising the second display surface, and wherein the first and second glass panels are bonded together.

13. The device of claim 12, further comprising a strip between the first and second edges.

14. The device of claim 1, wherein the first and second display segments as a whole comprise a single glass panel comprising a surface, wherein at least part of the surface of the single glass panel comprises the first and second display surfaces, and wherein there is no physical boundary between the first and second display surfaces.

15. The device of claim 14, wherein the single glass panel does not comprise a trace of bonding along either or both of the first and second edges.

16. The device of claim 1, wherein each of the first and second display surfaces has a shape selected from the group consisting of a square, a rectangle, a triangle and a polygon.

17. The device of claim 1, wherein the first and second display surfaces are substantially rectangular and of the same size.

18. The device of claim 1, further comprising a plurality of display segments, each of which comprises a display surface and an edge, wherein the plurality of display segments are arranged such that the display surfaces of the plurality of display segments in combination with the first and second display surfaces form a single display surface, which is substantially planar.

19. A method of displaying an image, the method comprising:
providing the device of claim 1; and
stimulating the device so as to simultaneously display a first image on the first display surface and a second image on the second display surface.

20. A method of displaying an image, the method comprising:
providing the device of claim 1; and
stimulating the device so as to display a single image on the substantially planar display surface.
